(19) United States
(12) Patent Application Publication
(10) Pub. No.: US 2019/0051272 A1
(43) Pub. Date: Feb. 14, 2019

(54) AUDIO EDITING AND PUBLICATION PLATFORM

(71) Applicant: CommonEdits, Inc., Dallas, TX (US)

(72) Inventors: Matthew S. Lewis, Dallas, TX (US); Christopher James Carr, Dallas, TX (US); Oluwatosin Awofeso, Dallas, TX (US); Zachary James Zukowski, Dallas, TX (US)

(21) Appl. No.: 16/058,443

(22) Filed: Aug. 8, 2018

Related U.S. Application Data
(60) Provisional application No. 62/542,684, filed on Aug. 8, 2017.

(51) Int. Cl. G10H 1/00; G06F 17/30

(52) U.S. Cl. CPC G10H 1/0025; G10H 2220/116; G10H 2240/325; G06F 17/30752

(57) ABSTRACT

Techniques are described for editing and publishing audio information, such as music files. A platform enables a user to browse samples of audio data, or upload a sample of audio data, to be modified (e.g., remixed) through the platform. Through the user interface (UI) of the platform, the user can browse available samples and select one or more samples for remix. The user can use the UI to select segments of the samples and modify the segments. The segments can be combined with user-configurable time ordering, repetition, pattern application, and/or other tools, to generate a new audio file that is a remix of the segments. The platform can be used to publish the remix and make it available to other users who may listen to the audio file and/or further modify or remix it with other audio samples to generate their own remix, providing a collaborative environment.

### CROSS-REFERENCE TO RELATED APPLICATIONS

This application claims the benefit under 35 U.S.C. § 119(e) of U.S. Patent Application No. 62/542,684, entitled “Audio Editing And Publication Platform,” filed Aug. 8, 2017, which is incorporated herein by reference in its entirety.

### BACKGROUND

In its original form, audio recording technology created analog recordings of audio (e.g., music) using traditional acoustic analog microphones to capture sound information in the form of a varying current driven by a vibrating diaphragm or other apparatus. The varying current could be used to store the captured audio information on an analog recording medium such as a phonograph record and, later, magnetic tape. Digital sound recording technology enabled the capture and storage of audio data in a digital format, such as on a compact disk (CD). Today, musicians and other content authors can use the internet to distribute digital audio files, and various streaming audio services provide advertising-based or subscription-based music services online for playback on various types of computing devices.

### SUMMARY

Implementations of the present disclosure are generally directed to a platform for editing and publication of audio content. More specifically, implementations are directed to a platform that enables a user to select various samples of audio data, excerpt segments of the samples, and modify and combine the segments in various ways to create a combination (e.g., a remix) of audio data that can then be published to other users of the platform, played, and/or shared.

In general, innovative aspects of the subject matter described in this specification can be embodied in methods that include actions of determining one or more audio tracks; identifying at least one segment for each of the one or more audio tracks; modifying the at least one segment for each of the one or more audio tracks; generating a remix of the at least one segment for each of the one or more audio tracks; and publishing the remix.

Implementations can optionally include one or more of the following features: the actions further include analyzing the remix to determine ownership information that describes a respective owner of one or more of the segments included in the remix; and/or the at least one segment is modified through one or more of a time spectrum alteration and a segment cluster selection.

Other implementations of any of the above aspects include corresponding systems, apparatus, and computer programs that are configured to perform the actions of the methods, encoded on computer storage devices. The present disclosure also provides a computer-readable storage medium coupled to one or more processors and having instructions stored thereon which, when executed by the one or more processors, cause the one or more processors to perform operations in accordance with implementations of the methods provided herein. The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that aspects and features in accordance with the present disclosure can include any combination of the aspects and features described herein. That is, aspects and features in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example platform for audio editing and publication, according to implementations of the present disclosure.

FIG. 2 depicts a flow diagram of an example process for audio editing and publication, according to implementations of the present disclosure.

FIG. 3 depicts a flow diagram of an example process for generating audio output in the style of audio input, according to implementations of the present disclosure.

FIGS. 4A-4C depict example user interface screens for determining sample(s) to be remixed, according to implementations of the present disclosure.

FIGS. 5A-5D depict example user interface screens for identifying and modifying sample segment(s) for remix, according to implementations of the present disclosure.

FIGS. 6A-6E depict example user interface screens for combining sample segment(s) to generate the remixed sample, according to implementations of the present disclosure.

FIG. 7 depicts an example screen 700 showing a visualization of the ownership information, according to implementations of the present disclosure.

FIG. 8 depicts an example screen 800 showing sample selection using clustering, according to implementations of the present disclosure.

FIG. 9 depicts an example computing system, according to implementations of the present disclosure.

### DETAILED DESCRIPTION

Implementations of the present disclosure are directed to a platform for editing and publishing audio information, such as music files. The platform enables a user to browse samples of audio data, or upload a sample of audio data, to be modified (e.g., remixed) through the platform. The audio data that is processed through the platform may include music files or other audio data that is not limited to music. Through the user interface (UI) of the platform, the user can browse available samples and select one or more samples (also referred to as tracks) for remix. The user can use the UI to select segments of the samples, and use various features of the platform (described below) to modify the segments as desired. The user can further use the UI to combine the segments, with user-configurable time ordering, repetition, pattern application, and/or other tools, to generate a new audio file that is a remix of the segments. The user can use the platform to publish the remix and make it available to other users who may listen to the audio file and/or further modify or remix it with other audio samples to generate their own remix. In this way, the platform provides a collaborative environment in which a community of users can collaborate or other influence each other's creative process in composing new audio works that are derivative of, and/or combinations of, previously uploaded content.

The audio samples available within the platform may include works that are owned, at least partly, under any suitable rights management regime, such as copyright, copyleft, or “copymiddle,” as well as works that are available in the public domain. In some implementations, the platform tracks ownership information for the various samples and the various segments of samples that are incorporated into derivative works such as remixes. Ownership tracking may be performed at any suitable level of granularity. In some implementations, segments as short as microseconds may be tracked for ownership information. In this way, the platform keeps track of ownership of the various components that may be incorporated into a remix, as well as the ownership rights of the creator of the remix or other derivative work generated using the platform. Ownership tracking information may then be used to ensure appropriate attribution and/or compensation for the various authors and/or owners of the constituent segments of audio data that were used to generate a remix.

In some implementations, the platform employs suitable machine learning (ML) technique(s) for various audio editing and remix generation features of the platform, to facilitate the creation of remixes. Such ML techniques are described further below.

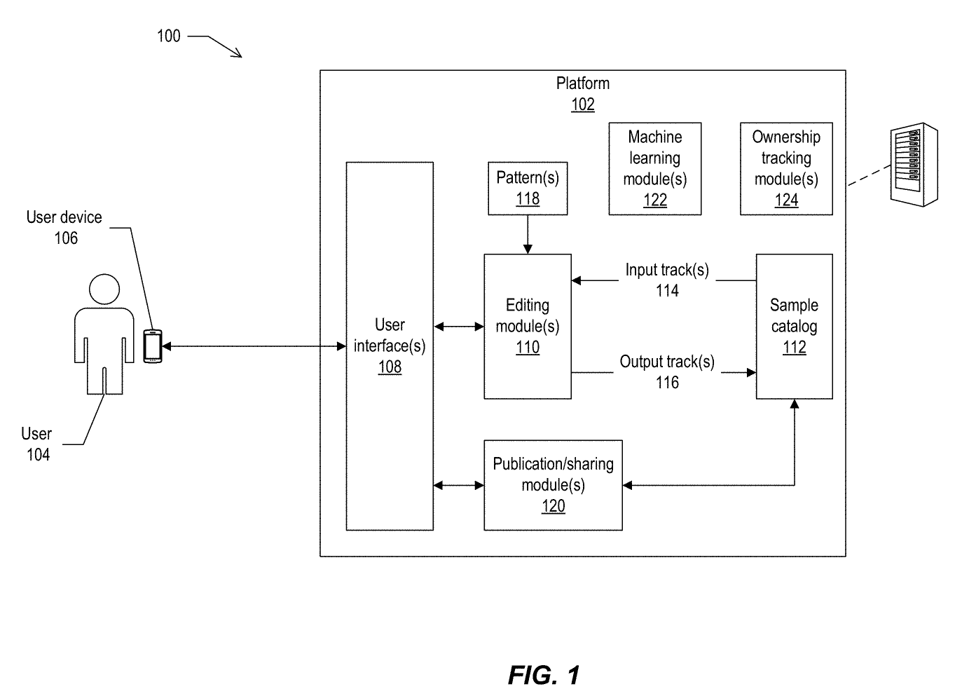

FIG. 1 depicts an example system 100 including a platform 102 for audio editing and publication, according to implementations of the present disclosure. As shown in the example of FIG. 1, a user 104 may operate a user device 106 to access the audio editing and publication platform 102 (as referred to as the platform). The user device 106 may be any suitable type of computing device, including portable computing device(s), such as a smartphone, tablet computer, wearable computer, etc., and less portable types of computing device(s), such as a desktop computer, laptop computer, and so forth. The platform 102 may execute on any suitable number and type of computing device(s). In some implementations, the platform 102 executes as a cloud service on one or more distributed computing device(s) (e.g., cloud server(s), cloud storage device(s), and so forth).

Access to the platform 102 may be through one or more user interfaces 108 executing on the platform 102 or otherwise exposed by the platform 102. In some implementations, the UI(s) 108 may be provided as a web site and the UI(s) 108 may be presented through a web browser, or other suitable container for web content, that is executing on the user device 106. In some implementations, the UI(s) 108 may be provided as component(s) of a (e.g., native) application, or app, executing on the user device 106.

The platform 102 may execute one or more editing module(s) 110 that provide various features for selecting samples, identifying segments of samples, modifying the sample segment(s), and/or combining the sample segment(s) to generate remixed audio data, as described herein. The platform 102 may also execute one or more publication/sharing module(s) 120 that support platform features for publishing samples and/or sharing samples with other users. The platform 102 may also execute one or more ML modules 122 and/or one or more ownership tracking modules 124, which provide functionality for ML and ownership tracking respectively, as described herein.

In some implementations, the platform 102 includes and/or has access to a sample catalog 112 (also referred to as the catalog). The catalog can store any suitable number of audio data files, such as music samples (tracks). The catalog can store the audio data using any suitable audio file format. The editing module(s) 110 may retrieve one or more input track(s) 114 from the catalog 112. The track(s) 114 may be manipulated and/or combined by the editing module(s) 110, according to the various commands provided by the user through the UI(s) 108, to generate one or more output tracks 116, such as a remix at least a portion of the input track(s) 114. The output track(s) 116 can be stored in the catalog 112 and published in the catalog to other users. The output track(s) 116 can also be shared with other users (e.g., other than the author of the track(s) 116), through social media, various types of messaging services (e.g., email, text messaging, etc.), and so forth. Tracks in the sample catalog 112 may be downloaded and/or played through any suitable audio player on the user device 106 or elsewhere. In some implementations, the editing module(s) 110 employ various pattern(s) 118 to modify the input track(s) 114 and generate the output track(s) 116. Such pattern(s) 118 are selectable by the user through the UI(s) 108, and are described further below. As used herein, the terms sample and track can each refer to a portion of audio data, such as a portion of music, of any suitable length and/or size.

The user can identify one or more samples to be used in generating a new remix. The user can browse the catalog of published samples to view information about the available samples, such as a name, author, length, timbre, genre, and/or other information regarding the sample(s). The user can search the catalog using search terms (e.g., as a search query). The user can also upload a new sample (e.g., a sample that is not already in the catalog) to be manipulated through the platform 102. The various samples that are browsed in the catalog, uploaded by the user, and/or present in search results, may be played by an audio player provided through the UI(s) 108. The catalog can store remixes and/or original tracks.

If the user selects a sample from the catalog, through browsing or searching, the editing module(s) 110 can make a copy of the sample for modification by the user, and the unmodified sample may continue being available through the catalog. Such copying can also be described as forking the sample, with a forked copy of the sample available for modification while the unmodified copy remains in the catalog. The published samples in the catalog can be licensable for use and/or modification by the user, and/or otherwise available (e.g., in the public domain). In some implementations, the sample catalog may provide various sample packs that each includes one or more tracks. A sample pack may provide a collection of samples that are in a particular genre or style of music, that are authored by a particular artist or group of artists, and/or that are suitable for a particular type of remix.

Using the various UI screens provided by the platform, the user can select one or more tracks, generate permutations and/or combinations of segments of the track(s), such as the various sounds in the track(s). The platform may enable the user to select segments of the track(s), and apply pattern(s) and/or filter(s), apply time-based permutations, reordering, repetitions of tracks, and/or other modifications of the selected segment(s). The user may use the platform to combine the segments (modified or unmodified) with any suitable ordering and/or layering of track segments to generate the remix.

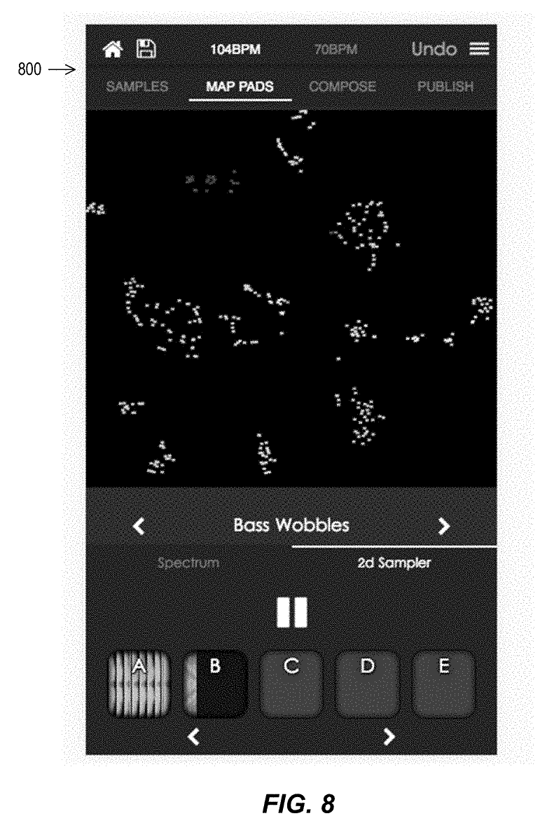

In some implementations, segment clustering may provide a tool for varying the segments used in the remix. Each track in the catalog may be analyzed to generate a (e.g., large) number of slices of the track, where each slice is an audio segment corresponding to an onset event in the audio. For example, a slice may encompass a particular note of music, percussion beat, or other audio event corresponding to some sort of change in the audio. The analysis may output, for a track, metadata that describes each of the slices, such that each slice has a characteristic fingerprint that is described in the metadata. The metadata may describe various characteristics of a slice of audio data, such as the length, start time and end time (within the larger sample), and sound features such as frequency, timbre, volume, spectral contrast (e.g., how pitched is the sound), and so forth. A clustering analysis may be performed to identify clusters of slices that exhibit similar sound features (e.g., similar fingerprints with respect to sound characteristics). In some implementations, the clustering may employ a ML algorithm, such as a version of the t-distributed stochastic neighbor embedding (t-SNE) algorithm for dimensionality reduction. For example, the clustering may produce clusters as a two-dimensional point. In some implementations, the platform may provide a screen that presents a visualization of the clustered audio slices. In some implementations, the platform provides a feature that allows the user to select a particular audio segment from a track, and cycle through other audio segments that clustered similarly to the selected audio segment. In this way, the user can access an audio palette of similar, though somewhat different sounds, to highly customize the particular sounds to be included in the remix. FIG. 8 depicts an example screen 800 showing sample selection using clustering (e.g., t-SNE clustering) in a two-dimensional space, which is also described as 2D sampling.

In some implementations, the platform enables the user to apply a pattern to a sample segment to modify the segment. A pattern can be associated with a particular style or genre of music, with a particular artist, or with other characteristics of the music. For example, a user can use the platform to select a segment of a sample and apply a pattern to the segment, to modify the segment to sound like the applied pattern (e.g., adopt characteristics of the pattern as far as rhythm, timbre, frequency, volume, pitch, and so forth). In some implementations, the various patterns may be generated using a machine learning algorithm that trains the pattern based on a large number of tracks in the style or genre, or that otherwise exhibit the characteristics to be patterned.

In some implementations, a suitable ML algorithm is used to generate a pattern that is a rhythm template for segment modification, the template generated based on input tracks for a particular genre or style of music, or for a large collection of music in various genres or styles. In some implementations, a recurrent neural network (RNN) technique is employed. The analysis can receive, as input, MIDI files (or raw audio input if sufficient processing power is available. The RNN can operate to predict a next note that is likely to occur in a drum pattern, based on the large number of drum patterns in the input files used to train the RNN. The template can then be used to request a percussion pattern in a particular style, of a particular length (e.g., eight beats). The generated template can be applied, through a tool in the UI, to modify segment(s) of track(s) being used in the remix. The ML algorithm may also generate MIDI files as output. In some implementations, the MIDI files are converted to JavaScript Object Notation (JSON) files that are readable by the platform. The output template may predict what percussion may be doing in a particular genre or style, such as the behavior of various percussion instruments (e.g., bass drum, snare drum, high hat, cymbal, etc.). The platform may also apply this technique to pitched instruments and/or simulated voices, to provide pattern templates to modify pitched instrument or voice track segments in a remix.

After a segment has been modified as desired by the user, the user can employ the UI to assign the segment to a pad. The various segments, assigned to various pads, can then be combined to create the remix. The modified segments can be combined, with tempo matching, to generate a new track as a remix of the segments from a single track or from different tracks. The platform also provides features that specify how the various segments are to be combined serially, in a specified order with specified repetition of the segments. The platform also enables the segments to be layered such that they play at least partly contemporaneously in the remix. After a pad-assigned segment has been incorporated into a new audio file (e.g., the remix), later modifications to the segment are propagated into all the tracks that include the segment as a component.

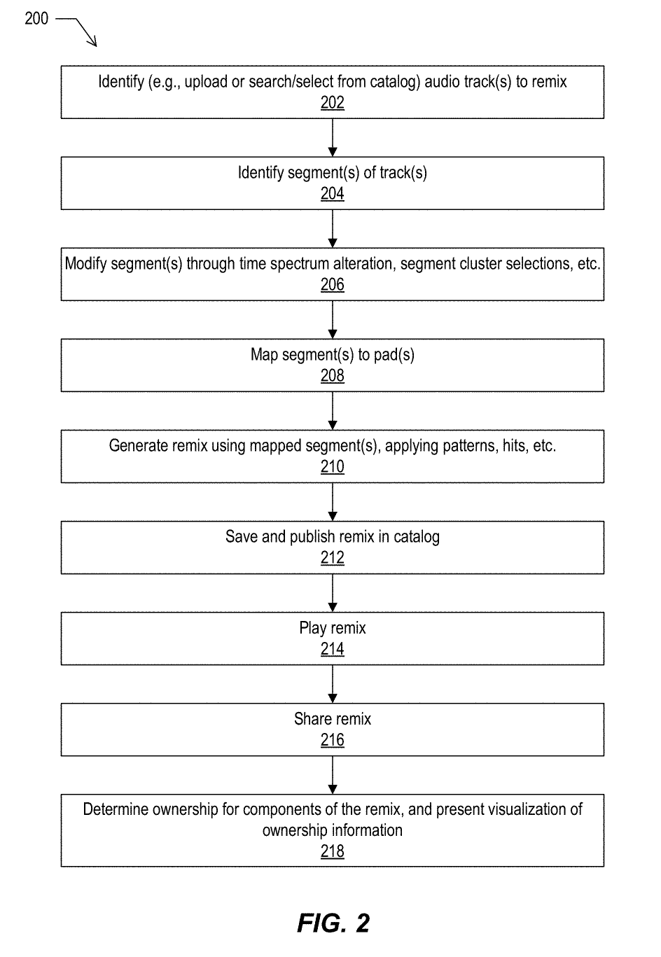

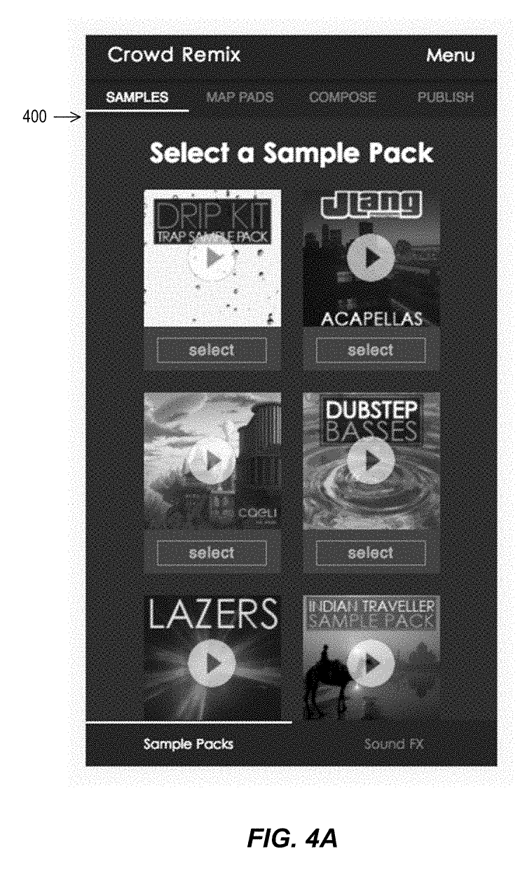

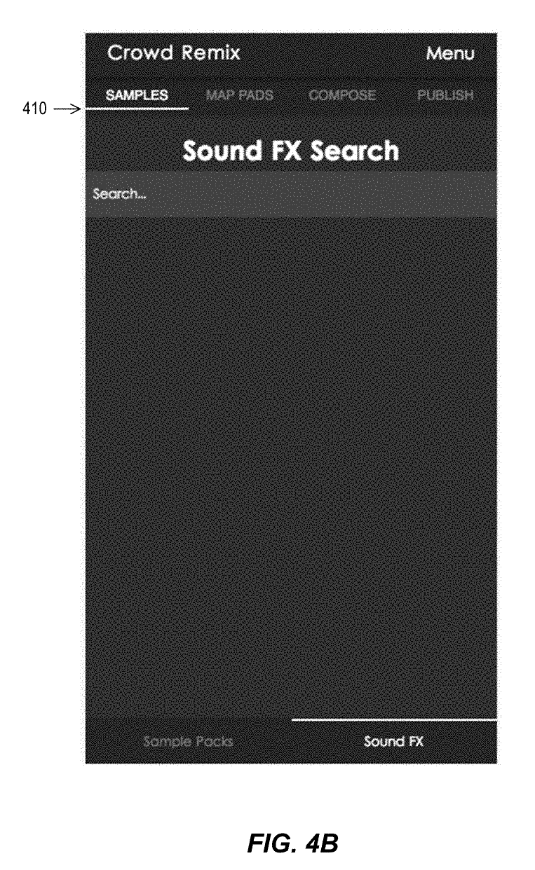

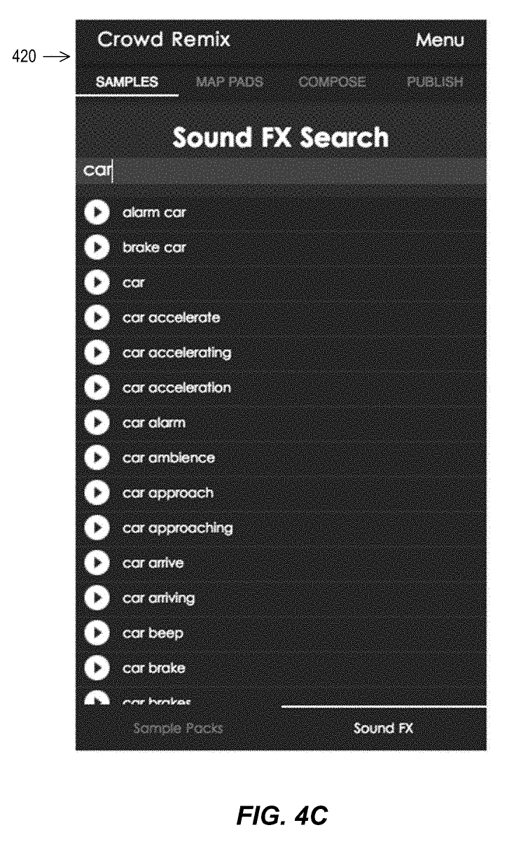

FIG. 2 depicts a flow diagram 200 of an example process for audio editing and publication, according to implementations of the present disclosure. Operations of the process may be performed by one or more of the UI(s) 108, the editing module(s) 110, the publication/sharing module(s) 120, the ML module(s) 122, the ownership tracking module(s) 124, and/or other software module(s) executing on the platform 102, the user device 106, or elsewhere. The various operations of FIG. 2 are described further with reference to the example UI screens of FIGS. 4A-4C, 5A-5D, and 6A-6E.

One or more audio tracks are identified (202) through the platform. As described above, the user may employ the platform to browse for samples in the catalog, search for samples in the catalog (e.g., through a keyword search), and/or upload their own samples for remixing.

One or more segments are identified (204) within the tracks. A segment can be a time portion of a track, with a particular start time, end time, and any suitable duration. The user can employ the platform to modify the segment(s) (206), through time spectrum alteration, segment cluster selection, and/or other modifications. The modified segments can be mapped (208) to pads, to specify an association between a pad and a particular segment for use in remixing.

The platform may be used to generate (210) a remix by combining the pad-mapped segments in any suitable order, with any suitable layer, and with any suitable repetition. As described herein, the platform may also modify the segments so that they play within the remix at a same tempo (e.g., beats per minute). The platform may also normalize the volume across segments, or perform other operations to merge the various segments into a remix.

The remix may be saved in the catalog and published (212), to be available to other users. The remix may be played (214) by the user who created the remix, and/or by other users, by accessing the remix in the catalog. The platform may also provide features that enable the author of a remix to share (216) the remix with others, through social media, email, text messaging, and/or other communications channels.

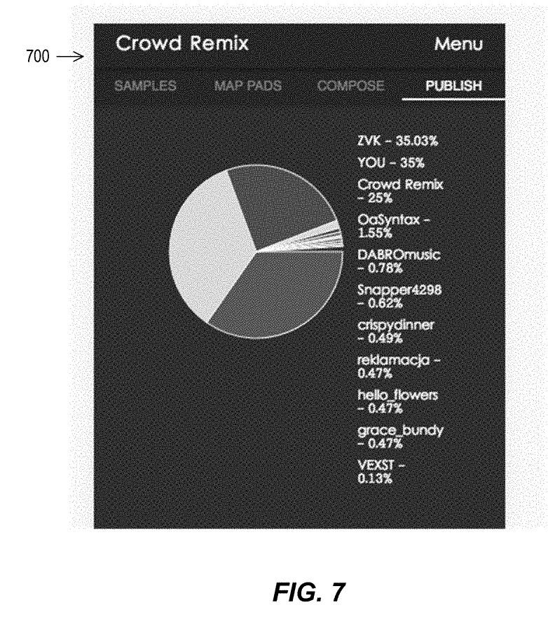

Ownership may be determined (218) for the various components in the remix. In some implementations, the platform performs an analysis of the remix to identify the various owners of the various component segments that were used to create the remix. The platform may track ownership of individual slices of each track that is processed through the platform, and maintain metadata describing the ownership status of each slice. The metadata may describe the owner of a slice, the licensing regime (if any) under which the slice is to be used, and so forth. The metadata may also describe start and end times of the slice, as described above. Tracking ownership individual at a granular level (per slice) enables the ownership information to be preserved as various tracks are divided into segments and combined for create remixes, over any number of iterations of combination and recombination. The granular ownership tracking enables the monetization of remixed and, if appropriate, accurate attribution of ownership and/or authorship in a combined derivative work. In some implementations, the platform may present a visualization of the ownership information for a remix, such as in a list, pie chart, or other suitable format. FIG. 7 depicts an example screen 700 showing a visualization of the ownership information, as a chart as well as a list of owners, showing the proportional ownership per owner.

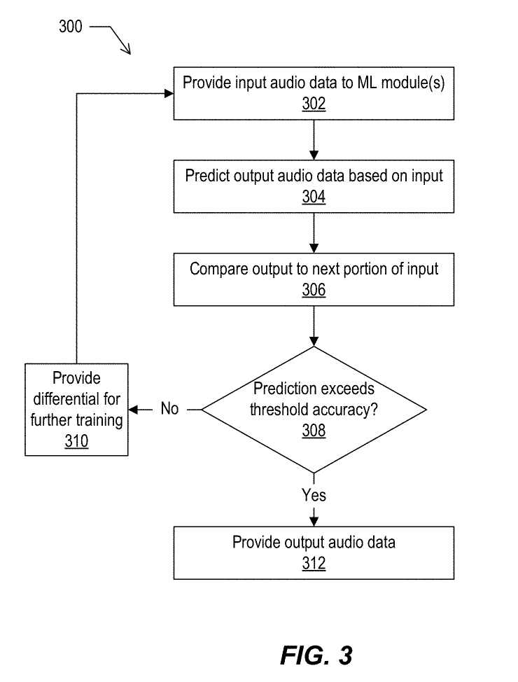

FIG. 3 depicts a flow diagram 300 of an example process for generating audio output in the style of audio input, according to implementations of the present disclosure. Operations of the process may be performed by one or more of the UI(s) 108, the editing module(s) 110, the publication/sharing module(s) 120, the ML module(s) 122, the ownership tracking module(s) 124, and/or other software module(s) executing on the platform 102, the user device 106, or elsewhere.

Input audio data is provided (302) to ML module(s), that analyze the input data to train a predictive model. The model may generate output audio data (304) that is a prediction of the sounds that are likely to come next, based on the characteristics of the input data. The output may be compared (306) to a next portion of the input data, as a check on the accuracy of the prediction. If the prediction exceeds a threshold accuracy (308), e.g., if the predicted output is sufficiently close to the next portion of input data, the predicted audio data may be provided as output by the model (312). If the prediction is not sufficiently accurate, the differential between the prediction and the actual next portion of audio data is provided (310) for further training of the model, to refine its prediction. Training may proceed in this manner until the threshold accuracy is reached, and the model is sufficiently accurately. In some instances, training may continue even after the threshold accuracy is reached, to further refine the model even as it is providing output to listeners. In some implementations, the output may be provided for presentation after a threshold accuracy has been reached, as described above. In some implementations, the determination may be time-based (e.g. stop training after two days) and/or or iteration-based (e.g. stop training after 40000 iterations), in addition to or instead of using the threshold accuracy.

In some implementations, the platform performs a deep learning generative algorithm on a collection of tracks by a particular artist or on a particular album, to train a model that predicts new audio output that sounds similar and/or is in the style of that artist or album. New music may then be synthesized that sounds like the artist or album, although it has not actually been composed by the particular artist or included on a particular album. In some implementations, a RNN technique is used in this analysis. A training set of audio data from a particular artist or album is provided as input, and the RNN predicts a next sequence of sounds based on the input data. In an initial phase, the model checks its prediction by comparing the predicted output to the input data in a next sequence. Any difference between the predicted audio data and the input audio data can then be used to refine the model and make it more accurate. Training in this way may continue until the confidence level in a prediction exceeds a threshold, e.g., until the predicted audio data is sufficiently close to the actual next sequence of sounds for a particular chunk of audio data. In some instances, the audio data may be analyzed in n-second (e.g., 4 second) chunks, for prediction and comparison to the next chunk of input data. This training process may be optimized by using a large number of GPUs or other processing units, and/or by using as input spectral data instead of the raw audio input for training the predictive model.

The output audio data may be generated with a similar tone, rhythm, frequency range, timbre, and/or other stylistic characteristics of the input data used to train the model. In some instances, the analysis does not generate output that includes generate words (e.g., lyrics) in any recognizable natural language, apart from words that may occur frequently in the input tracks used to train the model.

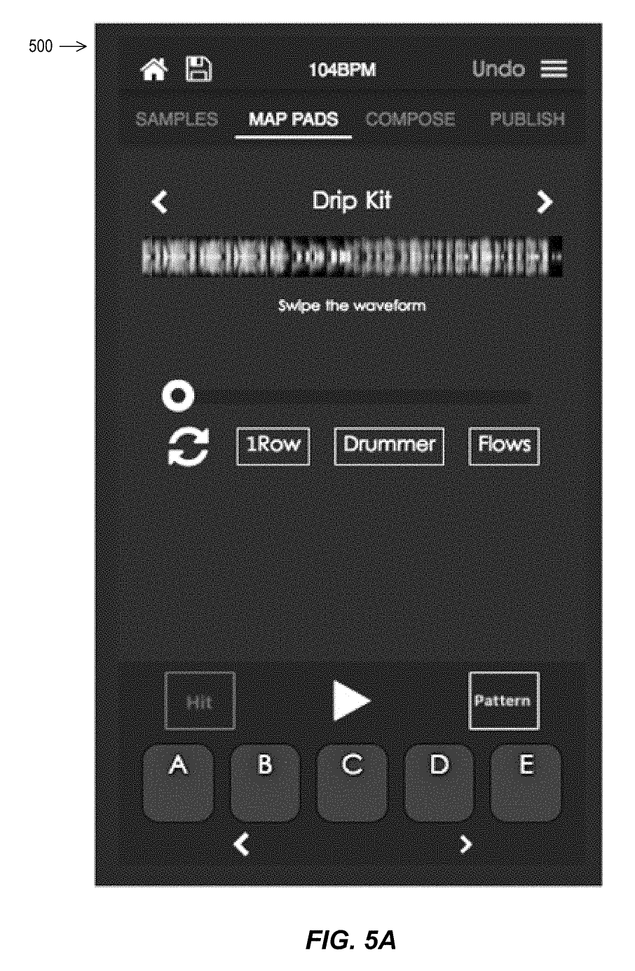

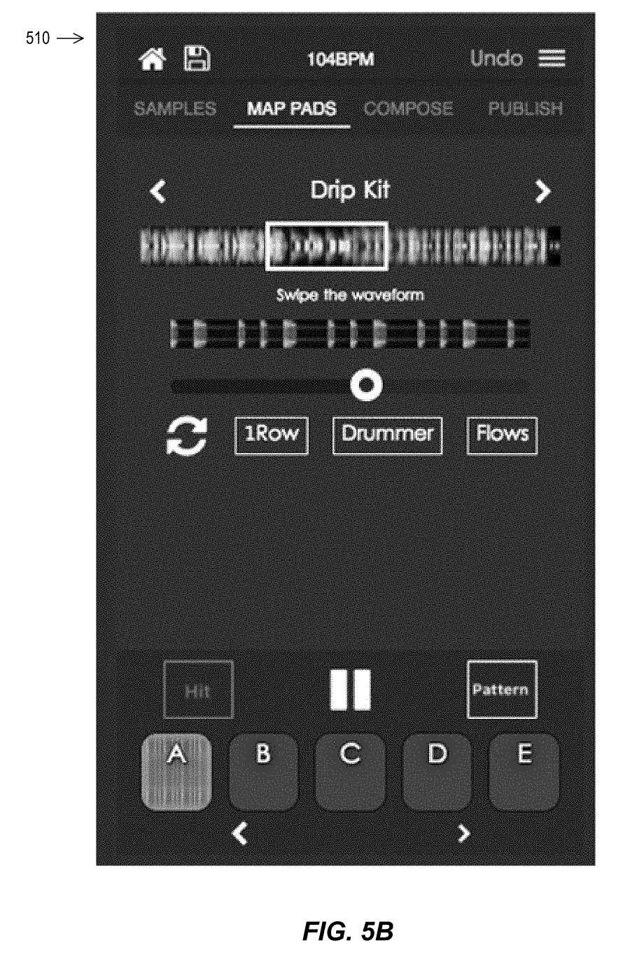

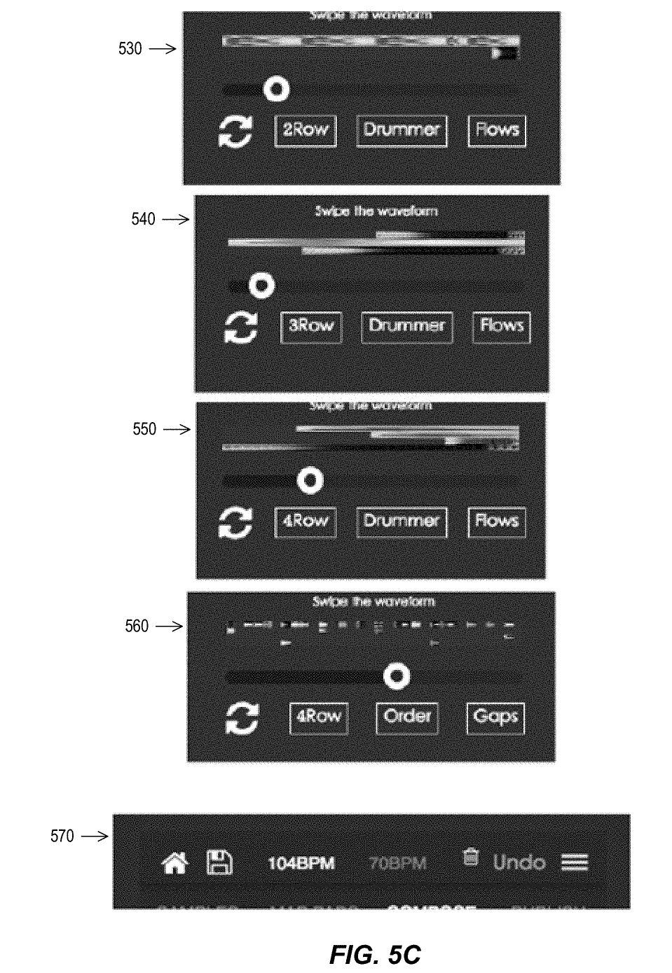

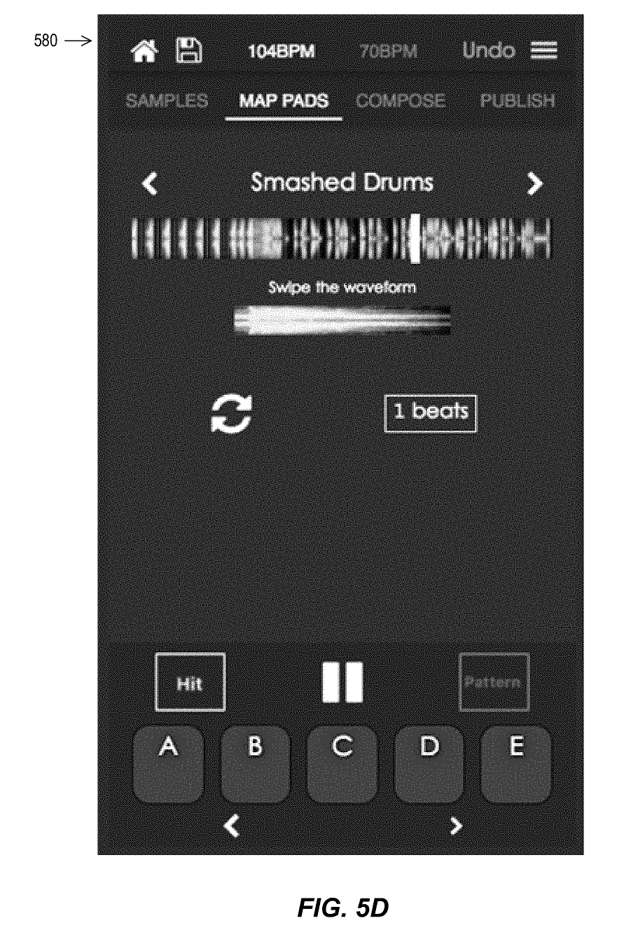

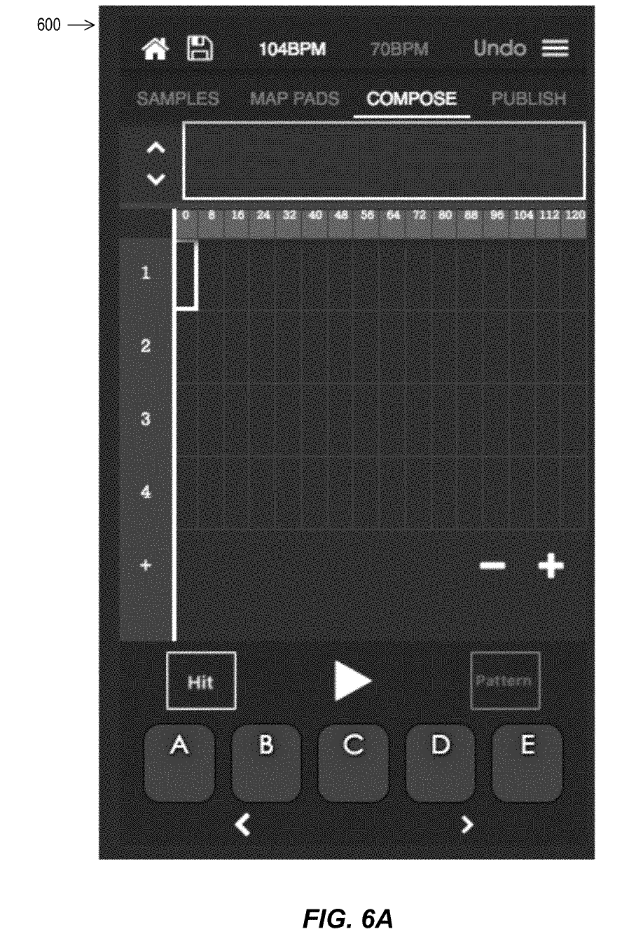

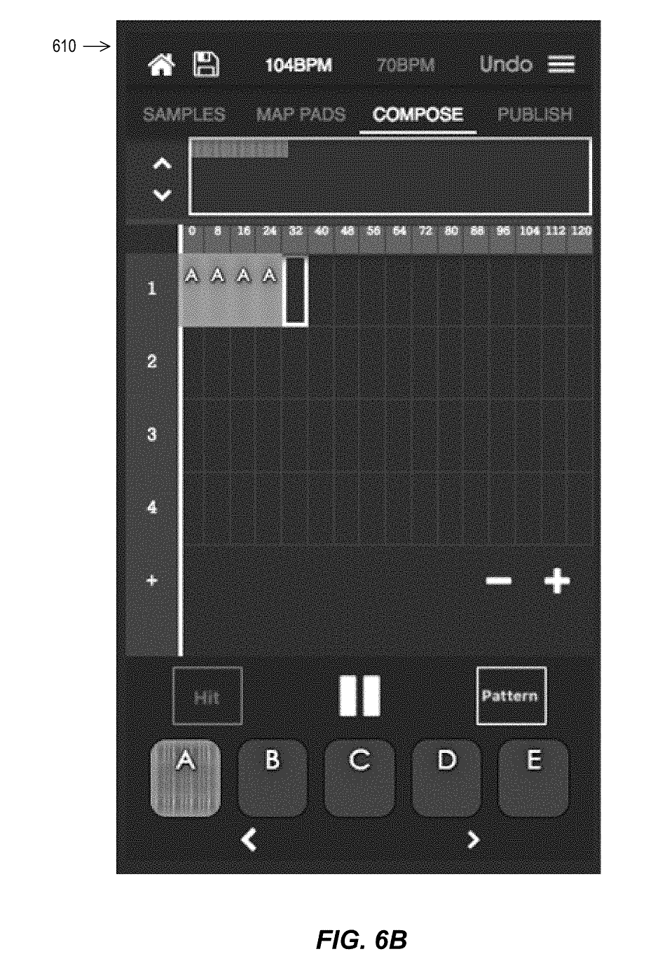

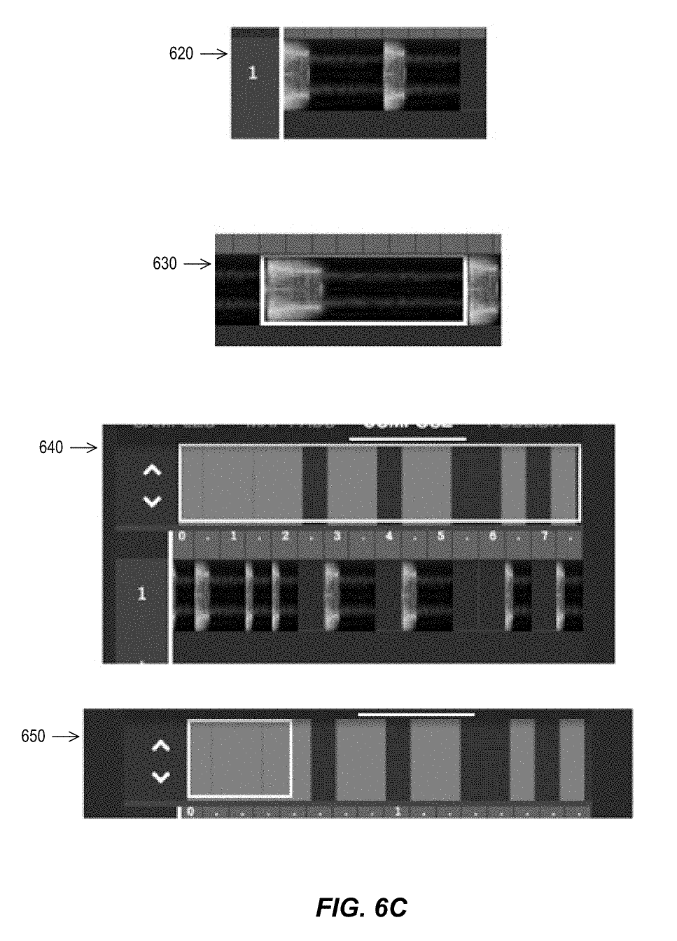

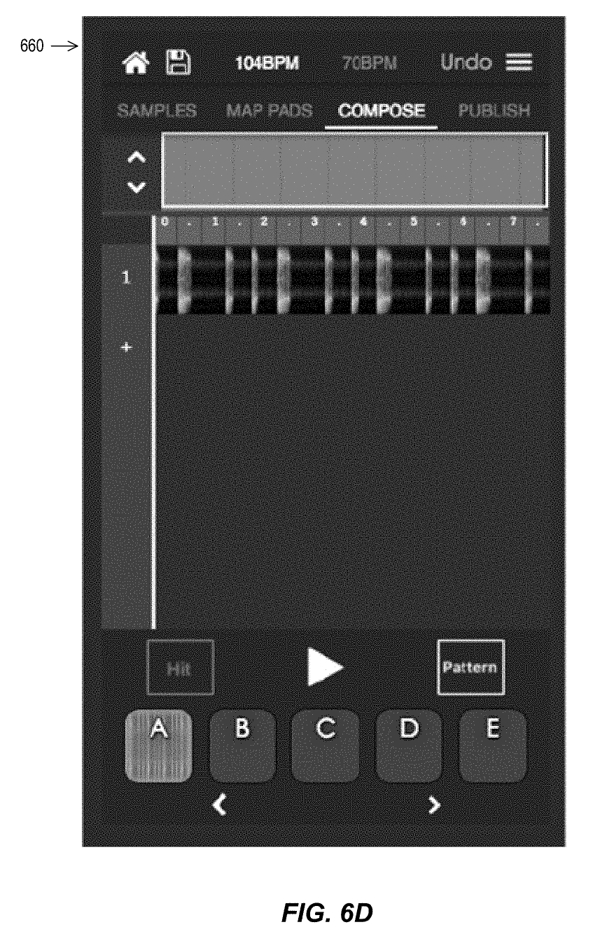

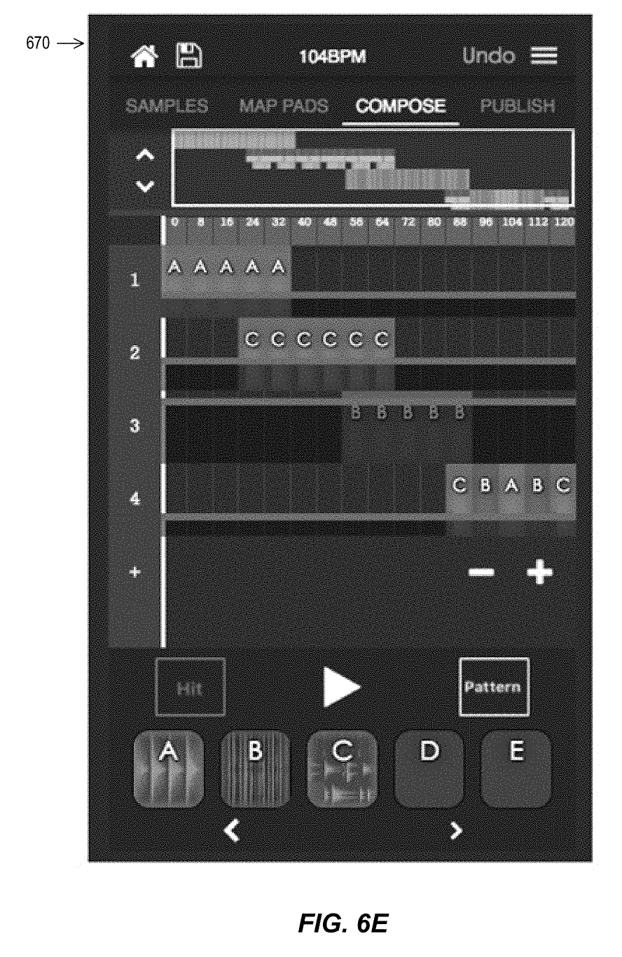

FIGS. 4A-4C, 5A-5D, and 6A-6E show example UI screens that may be presented by the platform 102, through the UI(s) 108. In these examples, the screens are presented within an application that includes four sections (e.g., tabs)—Samples, Map Pads, Compose, and Publish. FIGS. 4A-4C show features under the Samples section, FIGS. 5A-5D show features under the Map Pads section, and FIGS. 6A-6E show features under the Compose section. Access to the screens may be limited to those users who are registered with the platform, and who input the appropriate security credentials (e.g., username, password) to log into the platform and gain access. In some implementations, the user may be required to accept terms of service for the platform to gain further access to its features.

FIGS. 4A-4C depict example UI screens, presented through the UI(s) 108, for determining sample(s) to be remixed, according to implementations of the present disclosure.

FIG. 4A shows an example 400 of a UI screen used to browse the catalog. The screen is showing sample packs that are available in the catalog. The user may “Select” one or more of the sample packs to be included in the input tracks used to generate the remix. FIGS. 4B and 4C show examples 410 and 420 of UI screens used to search for sound samples in the catalog. The user may enter one or more search terms (e.g., “car”) in the search term input field in the screen, and the platform may search the catalog to identify sound samples that include the search term(s) in the name and/or description of the sound. The user may select one or more of the search results to be included in the input tracks used to generate the remix. In some implementations, as shown in FIG. 4C, the search results appear below the search term input field as the user types in the search term(s). The various tracks identified through browsing or searching the catalog may be played through an audio player included in the screen, to provide the user with a preview of the track(s) before deciding whether to use various track(s) in a remix.

FIGS. 5A-5D depict example UI screens, presented through the UI(s) 108, for identifying and modifying sample segment(s) for remix, according to implementations of the present disclosure. The user can use these screens to select segments of tracks, modify the segments, and assign the segments to pads for use in composing the remix.

FIG. 5A shows an example screen 500 that displays the waveform of a sample that the user selects through the Samples section of the application. All of the selected samples and/or sample packs may be accessible through the Map Pads section, and the “<” and “>” controls may be used to navigate among the selected samples. The user may click on the waveform to play the sample. Swiping the waveform, e.g., swiping the audio time spectrum of the waveform, selects a pool of one or more audio segments of the sample.

FIG. 5B shows an example screen 510 in which the user has selected a pool of segments from the sample, e.g., as a portion of the sample having a selected duration. The selection is shown below the larger waveform. Tapping one of the pads on the screen (e.g., A, B, C, D, E, etc.) assigns the currently selected segment(s) to the pad. In some implementations, the selection may play after it has been designated by the user. The slider control and the buttons on the screen may be used to generate rhythmic patterns used to concatenate audio segments in the currently selected pool of segments.

FIG. 5C shows example portions 530, 540, 550, 560, and 570 of the screen 510, in which the user has used the controls of the screen to specify various options for segment modification. As shown in 530, 540, and 550, clicking the “NRow” button changes the display to show different numbers of rows for layering of the audio segment. 2Row lets the segment to be layered in two separate layers that play contemporaneous, with each layer individually configurable by the user. Similarly, 3Row and 4Row specify 3 and 4 rows for layering. The Drummer button can be selected to toggle to the Order view, as shown in 560, to show the order of segments in the selected pool of segments. The Drummer button can also be used to toggle to a Chaos view. The Drummer/Order/Chaos button redistributes segments from the selected pool of segments to events in the pattern in different ways.

The display can also be toggled between Flows and Gaps to show the audio content or gaps in audio content respectively. The Flows/Gaps button changes the length of segment events in the pattern in different ways. As shown in 570, the user can tap a sample tempo (e.g., 104 BPM), and the master tempo auto-matches the tempos of the various segments to the selected tempo. In some implementations, the default master tempo is based on the tempo of one of the segment pools. The interface may allow the user to enter a master tempo and/or to select the master tempo from among the tempos of the various segments.

FIGS. 5A-5C show options available if the user has selected the Pattern options for this screen, where such options enable the user to select and modify the pattern of the audio. Modification can be performed through swiping in the various views shown in FIG. 5C, to modify the timing of the various rows to be layered. FIG. 5D shows an example screen 580 that is shown if the user selection the Hit options. Continuous phrases of any suitable duration may be created in the Hit options of the screen.

FIGS. 6A-6E depict example UI screens, presented through the UI(s) 108, for combining sample segment(s) to generate the remixed sample, according to implementations of the present disclosure. These figures depict features available under the Compose section of the application.

FIG. 6A shows a screen 600, with four rows available for layering in segments associated with the pads below. The number of rows can be increased using the “+” control. The columns in the grid correspond to time portions (beats) into which audio segments can be slotted to compose the remix. The Compose section is initially displayed with a blank arrangement, and a cursor indicating the first empty beat into which audio content can be added. FIG. 6B shows a screen 610 in which the user has tapped on an assigned pad to add that block of segments to the row selected by the cursor. Adding the segments may auto-advance the cursor to the next empty beat in the row. The frame above the grid in the screen shows the master composition. As shown in FIG. 6C, a block can be highlighted and stretched to make it shorter, as in 620, or longer, as in 630. The master composition can be zoomed using the up and down arrows, as shown in 640 and 650.

FIG. 6D shows a screen 660. As shown in this example, an assigned pattern block enters into its own compose editor when a filled pad is held down in the compose window. Changes made to the composition are propagated when the home icon is pressed. As shown in FIG. 6E, with example screen 670, beats, rows, and pads can be added for additional audio layering as desired by the user. The volume and effect level automation can be adjusted by tapping the row number and raising or lowering the blue bars. In this way, the platform allows the user to layer any appropriate number of pad-assigned segments of sample(s) to create the remix, with tempo auto-adjusted per the master tempo to create a remix according to the user's specifications.

The Publish section may include features that enable the user to publish a remix to the catalog to be searchable, browsable, playable, useable in remixes by other users. In some implementations, a published audio file is available as a static audio file in a suitable audio file format, available for downloading, saving, playing, and so forth. In some implementations, the platform provides a profile page for each user that is registered to the platform. The published tracks of the user may be listed on the user's profile page, to enable other users to readily view the items that the user has created through the platform. Each published track may be analyzed for ownership information as described above, and the results of the analysis are stored in data storage for later retrieval (e.g., through a HTTPS request). The Publish section of the application may include features that allow a user to name a track and initiate the audio render (to static format) and analysis. A saved track can also be published through the user's profile page. In some implementations, the various users of a published track (users who incorporated the track into their own remix) may also be listed in the profile page of the user who authored the published track. The Publish section may also include features to let the user add artwork to a track (e.g., an image or graphic design that is displayed with the track in the catalog). Links to published tracks may be shared through social networks or other communications channels.

In some implementations, the platform provides an audio player that enables users of the platform to play published tracks. The audio player may include features such as shuffle, repeat, and/or other audio playback functions (e.g., play, pause, fast forward, etc.). The audio player may include features that allow a listening user to like a track (e.g., thumbs up) and/or share a track through social media or other channels. In some implementations, the platform enables users to upload their tracks for live remixing.

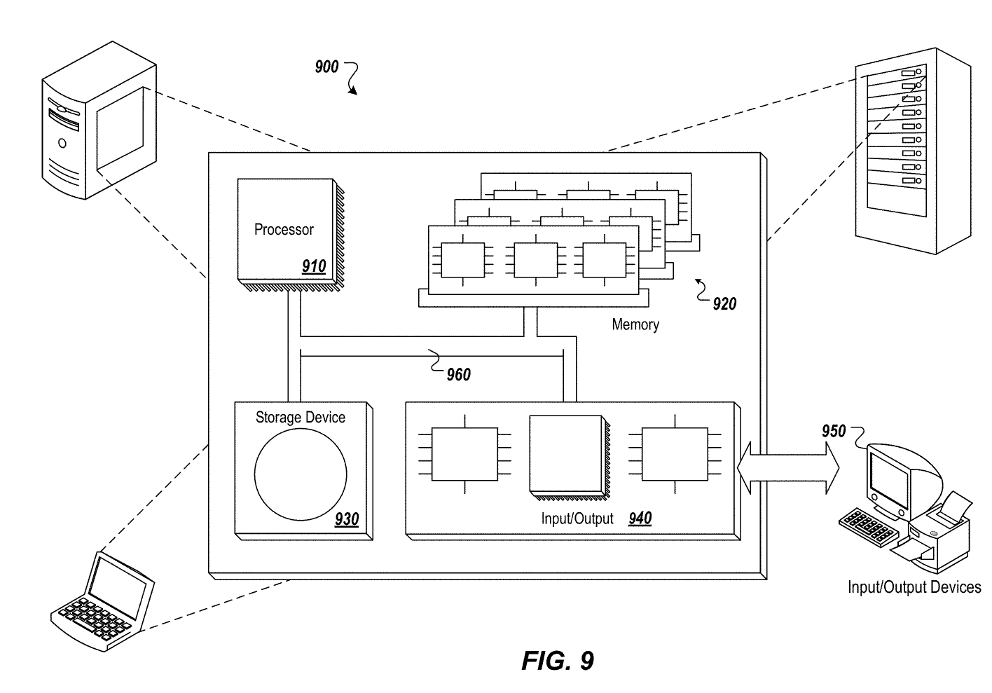

FIG. 9 depicts an example computing system 900, according to implementations of the present disclosure. The system 900 may be used for any of the operations described with respect to the various implementations discussed herein. For example, the system 900 may be included, at least in part, in one or more of the platform 102, user device 106, and/or other computing device(s) or system(s) described herein. The system 900 may include one or more processors 910, a memory 920, one or more storage devices 930, and one or more input/output (I/O) devices 950 controllable through one or more I/O interfaces 940. The various components 910, 920, 930, 940, or 950 may be interconnected through at least one system bus 960, which may enable the transfer of data between the various modules and components of the system 900.

The processor(s) 910 may be configured to process instructions for execution within the system 900. The processor(s) 910 may include single-threaded processor(s), multi-threaded processor(s), or both. The processor(s) 910 may be configured to process instructions stored in the memory 920 or on the storage device(s) 930. The processor(s) 910 may include hardware-based processor(s) each including one or more cores. The processor(s) 910 may include general purpose processor(s), special purpose processor(s), or both.

The memory 920 may store information within the system 900. In some implementations, the memory 920 includes one or more computer-readable media. The memory 920 may include any number of volatile memory units, any number of non-volatile memory units, or both volatile and non-volatile memory units. The memory 920 may include read-only memory, random access memory, or both. In some examples, the memory 920 may be employed as active or physical memory by one or more executing software modules.

The storage device(s) 930 may be configured to provide (e.g., persistent) mass storage for the system 900. In some implementations, the storage device(s) 930 may include one or more computer-readable media. For example, the storage device(s) 930 may include a floppy disk device, a hard disk device, an optical disk device, or a tape device. The storage device(s) 930 may include read-only memory, random access memory, or both. The storage device(s) 930 may include one or more of an internal hard drive, an external hard drive, or a removable drive.

One or both of the memory 920 or the storage device(s) 930 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 900. In some implementations, the CRSM may include a data store that provides storage of computer-readable instructions or other information in a non-transitory format. The CRSM may be incorporated into the system 900 or may be external with respect to the system 900. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, and flash memory devices; magnetic disks such as internal hard disks and removable disks; magneto-optical disks; and CD-ROM and DVD-ROM disks. In some examples, the processor(s) 910 and the memory 920 may be supplemented by, or incorporated into, one or more application-specific integrated circuits (ASICs).

The system 900 may include one or more I/O devices 950. The I/O device(s) 950 may include one or more input devices such as a keyboard, a mouse, a pen, a game controller, a touch input device, an audio input device (e.g., a microphone), a gestural input device, a haptic input device, an image or video capture device (e.g., a camera), or other devices. In some examples, the I/O device(s) 950 may also include one or more output devices such as a display, LED(s), an audio output device (e.g., a speaker), a printer, a haptic output device, and so forth. The I/O device(s) 950 may be physically incorporated in one or more computing devices of the system 900, or may be external with respect to one or more computing devices of the system 900.

The system 900 may include one or more I/O interfaces 940 to enable components or modules of the system 900 to control, interface with, or otherwise communicate with the I/O device(s) 950. The I/O interface(s) 940 may enable information to be transferred in or out of the system 900, or between components of the system 900, through serial communication, parallel communication, or other types of communication. For example, the I/O interface(s) 940 may comply with a version of the RS-232 standard for serial ports, or with a version of the IEEE 1284 standard for parallel ports. As another example, the I/O interface(s) 940 may be configured to provide a connection over Universal Serial Bus (USB) or Ethernet. In some examples, the I/O interface(s) 940 may be configured to provide a serial connection that is compliant with a version of the IEEE 1394 standard.

The I/O interface(s) 940 may also include one or more network interfaces that enable communications between computing devices in the system 900, or between the system 900 and other network-connected computing systems. The network interface(s) may include one or more network interface controllers (NICs) or other types of transceiver devices configured to send and receive communications over one or more networks using any network protocol.

Computing devices of the system 900 may communicate with one another, or with other computing devices, using one or more networks. Such networks may include public networks such as the internet, private networks such as an institutional or personal intranet, or any combination of private and public networks. The networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some implementations, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 900 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), implementations are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any appropriate kind of digital computer. Generally, a processor may receive instructions and data from a read only memory or a random access memory or both. Elements of a computer can include a processor for performing instructions and one or more memory devices for storing instructions and data. Generally, a computer may also include, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory may be supplemented by, or incorporated in, special purpose logic circuitry.

To provide for interaction with a user, implementations may be realized on a computer having a display device, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any appropriate form of sensory feedback, e.g., visual feedback, auditory feedback, or tactile feedback; and input from the user may be received in any appropriate form, including acoustic, speech, or tactile input.

Implementations may be realized in a computing system that includes a back end component, e.g., as a data server, or that includes a middleware component, e.g., an application server, or that includes a front end component, e.g., a client computer having a graphical UI or a web browser through which a user may interact with an implementation, or any appropriate combination of one or more such back end, middleware, or front end components. The components of the system may be interconnected by any appropriate form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other. The computing system may also include any number of peers which may be distributed and/or remote from one another. The peers may enter into peer-to-peer relationships and establish peer-to-peer connections for communications.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method performed by at least one processor, the method comprising:
determining, by the at least one processor, one or more audio tracks;
identifying, by the at least one processor, at least one segment for each of the one or more audio tracks;
modifying, by the at least one processor, the at least one segment for each of the one or more audio tracks;
generating, by the at least one processor, a remix of the at least one segment for each of the one or more audio tracks; and
publishing, by the at least one processor, the remix.

2. The method of claim 1, further comprising:
analyzing, by the at least one processor, the remix to determine ownership information that describes a respective owner of one or more of the segments included in the remix.

3. The method of claim 1, wherein the at least one segment is modified through one or more of a time spectrum alteration and a segment cluster selection.
